(19) United States
(12) Patent Application Publication
(10) Pub. No.: US 2018/0115866 A1
(43) Pub. Date: Apr. 26, 2018

(54) LOW POWER GEOGRAPHICAL VISIT DETECTION

(71) Applicant: Microsoft Technology Licensing, LLC, Redmond, WA (US)

(72) Inventors: Fernando Gonzalez, Bellevue, WA (US); Priyanka B. Vegesna, Redmond, WA (US)

(21) Appl. No.: 15/632,172

(22) Filed: Jun. 23, 2017

Related U.S. Application Data
(60) Provisional application No. 62/411,531, filed on Oct. 21, 2016.

(51) Int. Cl. H04W 4/02; G06F 1/32; G06F 17/30

(52) U.S. Cl. CPC H04W 4/021; G06F 17/30241; G06F 1/3293

(57) ABSTRACT

A visit detection system is described for reduced power location determinations for geographical visit detection. The system limits active operations for determining a location of a computing device to intervals when those active operations have an increased likelihood of detecting a visit. The intervals may be identified by determining a kinematic state of the computing device. The kinematic state may be determined by passively monitoring existing signals of the computing system and opportunistic location data generated by applications on the computing device.

### CROSS REFERENCE TO RELATED APPLICATIONS

The present invention claims benefit under 35 U.S.C. § 119(e) of U.S. provisional application No. 62/411,531, filed Oct. 21, 2016, the contents of which are hereby incorporated by reference into this disclosure in their entirety.

### BACKGROUND

An increasing number of application developers are building location-aware applications that leverage information about a user's location to provide contextual experiences. In providing such contextual experiences, a location-aware application executing on a mobile device associated with a user may detect new or recurring locations that the user visits. The location-aware application may always requiring monitoring in the background. Such background monitoring is distinguishable from an application directly submitting a request (e.g. a Yelp request) for the mobile device's current location in the moment.

### BRIEF DESCRIPTION OF THE DRAWINGS

FIG. 1 is a system diagram of an example computer environment, in accordance with an embodiment.

FIG. 2 is a block diagram of a visit detection system, in accordance with an embodiment.

FIG. 3 is a state diagram showing four modes of operation of an example computing system and example transitions between modes of operation, in accordance with an embodiment.

FIG. 4 is a flow diagram showing an example method of operating a visit detection system with multiple modes of operation by monitoring passive kinematic signals.

FIG. 5 is a flow diagram showing an example method of operating a visit detection system with multiple modes of operation by monitoring passive kinematic signals.

### DETAILED DESCRIPTION OF EMBODIMENTS

Disclosed herein are methods, systems, and computer readable storage media that provide for reduced power location determinations for geographical visit detection. Active operations for determining a location of a computing device may be limited to intervals when those active operations have an increased likelihood of detecting a visit.

These intervals may be identified by determining a kinematic state of the computing device. As used herein, “kinematic state” refers to a change in the computing device's state of motion associated with a change in the computing device's location over time. The kinematic state may be determined by passively monitoring existing signals of the computing system and opportunistic location data generated by applications on the computing device. As used herein, such existing signals and opportunistic location data usable to identify a kinematic state of a computing device will be referred to as “passive kinematic signals.” In an embodiment, passive kinematic signals include existing signals that indirectly suggest a kinematic state of the computing device. For example, a signal indicative of the computing device being connected to a docking station while not directly indicative of a kinematic state of the computing device does indirectly suggest that the computing device may be stationary. Such indirect passive kinematic signals may be used as a low probability suggestion of the current kinematic state. The accuracy of the determined kinematic state has an associated uncertainty, so the determined kinematic state may have a score (or metric). The score quantifies a likelihood of the determined kinematic state coincides with an actual kinematic state of the computing device.

Since kinematic state determinations are mostly passive in that they rely on passive kinematic signals, such determinations do not significantly deplete the computing device's available resources. As such, a kinematic state-based visit detection engine could strategically limit the number active operations, which thereby facilitates budgeting of active operations. That is, a kinematic state-based visit detection engine could better steward a computing device's available resources by triggering active operations only when doing so is likely needed for visit detection.

If visits were detected by periodically triggering (e.g., every five minutes) active operations for determining the current location of the computing device, it may excessively deplete the computing device's available resources. For example, determining the current location by periodically polling a global positioning system (“GPS”) receiver of the computing device may quickly deplete the available power. As another example, determining the current location by periodically querying a positioning server associated with a telecommunications provider that providing services to the computing device via cellular network may quickly exceed a data limit set by the telecommunications provider.

Moreover, if visits were detected by relying on opportunistic positions generated by other applications on the computing device, it may not adequately function without a sufficient amount of location based activity taking place on the computing device. For example, if there were not any other applications on the computing device generating opportunistic positions, there would not be any opportunistic positions available to detect a visit. Also, each opportunistic position generated by the other applications would further deplete the computing device's available resources.

These difficulties may be overcome using kinematic state-based visit detection engines with multiple modes of operation. For example, a visit detection engine may be implemented by a system using a state machine with four location determination operating modes: an unknown mode, a suspect mode, a stay mode, and a move mode. Each mode among the four location determination operating modes may correspond with a kinematic state of the system.

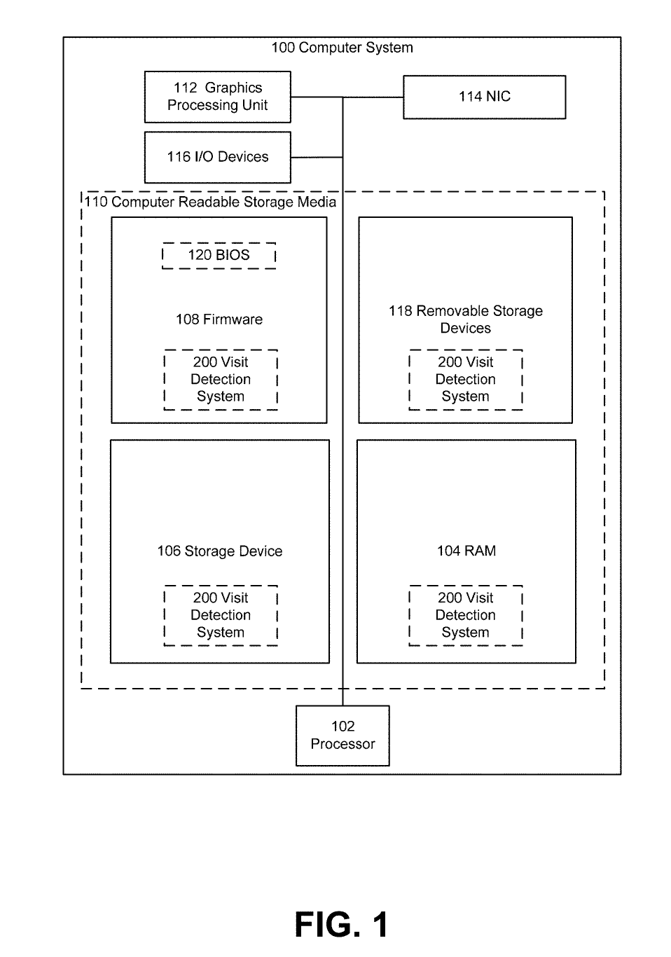

Referring to the figures generally and initially to FIG. 1 in particular, an exemplary computing environment in which embodiments of the present invention may be implemented is depicted and generally referenced as computing environment 100. As utilized herein, the phrase “computing environment” generally refers to a dedicated computing device with processing power and storage memory, which supports operating software that underlies the execution of software, applications, and computer programs thereon.

As shown by FIG. 1, computing environment 100 includes processor 110 (e.g., an execution core) that is interconnected by one or more system buses that couple various system components to processor 110. While one processor 110 is shown in the example depicted by FIG. 1, one skilled in the art will recognize that computing environment 100 may have multiple processors (e.g., multiple execution cores per processor substrate and/or multiple processor substrates each having multiple execution cores) that each receive computer-readable instructions and process them accordingly. The one or more system buses may be any of several types of bus structures including a memory bus or memory controller, a peripheral bus, and a local bus using any of a variety of bus architectures. In an embodiment, computing environment 100 also includes a host adapter, Small Computer System Interface (SCSI) bus, and an external storage device connected to the SCSI bus.

Computing environment 100 also typically includes or has access to various computer-readable media. Computer-readable media is any available media accessible to computing environment 100 that embodies computer-readable, processor-executable instructions. By way of example, and not limitation, computer-readable media includes computer-readable storage media 110 and communication media. Aspects of the present disclosure are implemented by way of computer-readable, processor-executable instructions that are stored on or transmitted across some form of computer-readable media.

Communication media typically embodies computer-readable instructions, data structures, program modules or other data in a modulated data signal such as a carrier wave or other transport mechanism and includes any information delivery media. “Modulated data signal”, as used herein, refers to a signal having one or more characteristics that each may be configured or modified to encode data into the signal for propagation through a communication channel. Examples of such communication channels include wired media such as a wired network or direct-wired connection, and wireless media such as acoustic, RF, infrared and other wireless media.

Computer-readable storage media 110 can include, for example, random access memory (“RAM”) 104; storage device 106 (e.g., electromechanical hard drive, solid state hard drive, etc.); firmware 108 (e.g., FLASH RAM or ROM); and removable storage devices 118 (e.g. CD-ROMs, floppy disks, DVDs, FLASH drives, external storage devices, etc). It should be appreciated by those skilled in the art that other types of computer-readable storage media can be used such as magnetic cassettes, flash memory cards, and/or digital video disks. Generally, such computer-readable storage media can be used in some embodiments to store processor executable instructions tangibly embodying aspects of the present disclosure. Consequently, computer-readable storage media explicitly excludes signals per se.

Computer-readable storage media 110 can provide non-volatile and/or volatile storage of computer-readable, processor-executable instructions, data structures, program modules and other data for computing environment 100. A basic input/output system (BIOS″) 120, containing the basic routines that help to transfer information between elements within computing environment 100, such as during start up, can be stored in firmware 108. A number of programs may be stored on firmware 108, storage device 106, RAM 104, and/or removable storage devices 118. These programs can include an operating system and/or application programs. In a specific embodiment, computer-readable storage media 110 of a computing environment 100 can store visit detection system 200, which is described in more detail in the following paragraphs. In this example embodiment, visit detection system 200 can be executed by processor 110 thereby transforming computing environment 100 into a computer environment configured for a specific purpose, i.e., a computer environment configured according to techniques described in this disclosure.

With continued reference to FIG. 1, commands and information may be received by computing environment 100 through input/output devices (“I/O devices”) 116. I/O devices 116 include one or more input devices, output devices, or a combination thereof. Examples of input devices include a keyboard, a pointing device, a touchpad, a touchscreen, a scanner, a microphone, a joystick, and the like. Examples of output devices include a display device, an audio device (e.g. speakers), a printer, and the like. These and other I/O devices are often connected to processor 110 through a serial port interface that is coupled to the system bus, but may be connected by other interfaces, such as a parallel port, game port, or universal serial bus (USB). A display device can also be connected to the system bus via an interface, such as a video adapter which can be part of, or connected to, a graphics processor unit.

Computing environment 100 may operate in a networked environment and receive commands and information from one or more remote computers via logical connections to the one or more remote computers, such as a remote computer. The remote computer may be another computer, a server, a router, a network PC, a peer device or other common network node, and typically can include many or all of the elements described above relative to computing environment 100.

When used in a LAN or WAN networking environment, computing environment 100 can be connected to the LAN or WAN through network interface card (“NIC”) 114. NIC 114, which may be internal or external, can be connected to the system bus. In a networked environment, program modules depicted relative to computing environment 100, or portions thereof, may be stored in the remote memory storage device. It will be appreciated that the network connections described here are exemplary and other means of establishing a communications link between the computers may be used. Moreover, while it is envisioned that numerous embodiments of the present disclosure are particularly well-suited for computerized systems, nothing in this document is intended to limit the disclosure to such embodiments.

In a networked environment, program modules depicted relative to computing environment 100, or portions thereof, may be stored in a remote memory storage device accessible via NIC 114. It will be appreciated that the network connections shown are exemplary and other means of establishing a communications link between the computers may be used. In an embodiment where computing environment 100 is configured to operate in a networked environment, the operating system is stored remotely on a network, and computing environment 100 may netboot this remotely-stored operating system rather than booting from a locally-stored operating system. In an embodiment, computing environment 100 comprises a thin client having an operating system that is less than a full operating system, but rather a kernel that is configured to handle networking and display output.

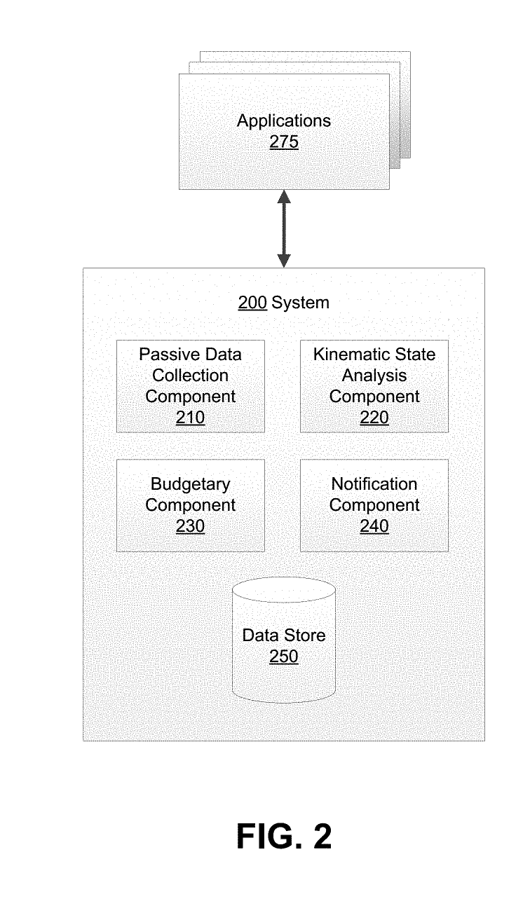

Turning now to FIG. 2 is a block diagram illustrating an example visit detection system 200 suitable for implementing reduced power location determinations for geographical visit detection, in accordance with one or more embodiments. In an embodiment, system 200 may be implemented as a single computing device, such as computing environment 100 of FIG. 1. System 200 may take on any of a variety of forms. By way of example, server 100 may be a mobile telephone, smart phone, laptop computing device, desktop computing device, server, tablet computer, personal digital assistant (PDA), a wearable computer, a gaming device, or any other computing device.

In an embodiment, system 200 may be implemented by multiple computing devices, such as computing environment 100 of FIG. 1 and at least one server component accessed via a network connection (e.g., a cellular network, a WiFi/broadband network, a local area network, and the like). The at least one server component may comprise a single computing device or multiple computing devices cooperating in a distributed environment. For example, the at least one server component may be provided via multiple computing devices arranged in a distributed environment that collectively provide one or more of the functionalities described herein.

As shown by FIG. 2, system 200 includes such components as passive data collection component 210, kinematic state analysis component 220, budgetary component 230, notifications component 240, and data store 250. Passive data collection component 210 is generally responsible for receiving (acquiring, obtaining, or accessing) passive kinematic signals from one or more sources. In an embodiment, the passive kinematic signals may be received by passive data collection component 210 and stored in one or more data stores, such as data store 250. The one or more data stores may thus be available to kinematic state analysis component 220, budgetary component 230, and notification component 240.

Passive kinematic signals may be received from a variety of sources. By way of example, passive kinematic signals may include device state data, network connection data, application activity data, inertial data (e.g., accelerometer, gyroscopes, and magnetic field sensors), and the like. In an embodiment, any type of existing signal is usable as a passive kinematic signal as long as it increases or decreases a likelihood that the computing device is in a specific kinematic state. Device state data may include information indication of a connection to an alternating current (“AC”) source or a docking station, an airplane mode setting of the computing device being in an “OFF” position, user interaction with or proximity to the computing device, time zone updates (e.g., a change in a cellular network identity and time zone “NITZ”), receiving tracking status events from a hardware (“HW”) offloaded (low power) tracking engine, and the like.

Network connection data may include information, such as whether the computing device is paired with a vehicle's Bluetooth system, wired Ethernet connections, wireless access point connections, variations in a number of visible wireless access points (e.g., Wifi basic service set identifiers), signal strength measurements (e.g., received signal strength indicator values) associated with visible wireless access points, and the like. Application activity data may include information, such as whether a user is capturing image data with a camera of the computing device, credit card or other payment transactions completed with the computing device (e.g., an near field communication “NFC” tap), completion of a navigation session associated with a mapping application, receiving geo-fence events for geo-fences set by other applications (e.g., applications 275), and the like.

Passive kinematic signals may also include derived data. As another example of a raw system signal that can be used as a passive kinematic signal includes: “user is active on the device”. Examples of derived signals include: “user active, to take a picture”; “user active, to turn airplane mode OFF”; and the like. In an embodiment, some derived signals may be a stronger indication that a computing device is in a stay state than raw signals. As used herein, “derived data” refers to data indicative of a kinematic state of a computing device that is derived from other passive kinematic signals. For example, derived data may include velocity data associated with the computing device that is derived from GPS positions opportunistically obtained from unrelated applications (e.g., applications 275), system activity, and the like. As another example, derivative data may include inertial data derived based on recent location determinations.

Kinematic state analysis component 220 is configured to determine scores (or metrics) for kinematic states based on the passive kinematic signals and statistical information associated with the scores. A score determined for a kinematic state indicates a likelihood that an actual kinematic state of the computing device corresponds to the kinematic state. In an embodiment, a score may be expressed as percentages, discrete enumerations (e.g., low, high, or unknown), or a combination thereof. Examples of statistical information may include any combination of confidence scores, variance metrics, central tendency values, probability distribution functions, and the like. In determining a score for a kinematic state, kinematic state analysis component 220 may receive one or more passive kinematic signals as input and provide the score for that kinematic state as output. The passive kinematic signals may be received at any level of granularity including: continuously, periodically (e.g., every minute, ten minutes, hour, three hours, etc.), or upon transitioning logic states (e.g., on to off, high to low, etc.).

Subject to design complexity and efficiency constraints, kinematic state analysis component 220 may utilize various functions to determine scores for kinematic states based on passive kinematic signals. In an embodiment, a score may be determined by taking a weighted average of individual passive kinematic signals. In an embodiment, a score may be determined in part using actively obtained signals indicative of a kinematic state. In an embodiment, weights may be determined using training data obtained from data sets composed of previously-received passive kinematic signals. For example, a computing device may run in a test mode in which passive kinematic signals are collected along with GPS receiver signals providing verified stay and move states associated with the passive kinematic signals. That is, location data may be obtained every N minutes to obtain a ground truth that could be correlated with the passive kinematic signals to generate training data. In an embodiment, a score may be determined using a custom code implemented in a programming language of choice that defines relationships between individual passive kinematic signals and an actual kinematic state of the computing device.

In an embodiment, any known artificial intelligence, machine learning, knowledge-based, or rule-based mechanisms to train machine learned models that receive passive kinematic signals as input and provide a score for a kinematic state as an output. Examples of such mechanisms include support vector machines, neural networks, expert systems, Bayesian belief networks, fuzzy logic, data fusion engines, classifiers, and the like. In training the machine learned models (e.g. find optimal values of for model parameters), objective functions may be used to measure the performance of the models using a subset of the training data as a function of the model parameters. For example, optimal values of the parameters of a model may be determined by finding a minimum of the objective function.

As another example, multiple iterations of a stochastic gradient descent procedure may be performed to find the optimal values of the parameters. In an embodiment, the machine learning model is composed of a single level of linear or non-linear operations. In an embodiment, the machine learning model is a deep network composed of multiple levels of non-linear operations. For example, the machine learning model may be a neural network with one or more hidden layers.

As an example, kinematic state analysis component 220 may determine a score for a stay state using a logistic function. One skilled in the art will recognize that one property of logistic functions is that for any value of an input (i.e., independent variable) an output value is always within a range of [0,1], which makes logistic functions suitable for probabilistic applications. In this example, kinematic state analysis component 220 provides three (Boolean) passive kinematic signals as input to a logistic function. The three passive kinematic signals of this example are: (i) whether the computing device is connected to WiFi (“WiFi”); (ii) whether the computing device is connected to a docking station (“docked”); and (iii) whether the computing device is paired with a vehicle's Bluetooth system (“carkit”). One skilled in the art will recognize that kinematic state analysis component 220 may provide a score based on dozen or even hundreds of passive kinematic signals. In an embodiment, passive kinematic signals may be categorized as categorical or continuous.

Kinematic state analysis component 220 in this example may provide the three passive kinematic signals into the following stay state equation to determine a score for the stay state:

$${P}_{stay} ( WiFi , docked , carkit ) = \frac{1}{1 + {e}^{- ( 0.5 * WiFi + docked - 1.2 * carkit )}} \qquad Equation 1$$

The stay state equation of this example demonstrates several things. First, in the absence of all three passive kinematic signals (i.e., Wifi=0, docked=0, carkit=0), a score for the stay state is 0.5. In this example, this 0.5 score for the stay state may be used as an “indeterminate” threshold that indicates there is insufficient information available to determine the computing device is in a stay state.

Second, the stay state equation of this example also demonstrates that some passive kinematic signals may increase the likelihood that the computing device is in a given kinematic state (i.e., a positive correlation exists), while other passive kinematic signals may decrease the likelihood that the computing device is in a given kinematic state (i.e., a negative correlation exists). Here, the “WiFi” and “docked” passive kinematic signals increase the likelihood that the computing device is in a stay state. In contrast, the “carkit” passive kinematic signal decreases the likelihood that the computing device is in the stay state because the computing device is potentially in a moving vehicle, and thus not staying.

Third, individual passive kinematic signals may be weighted to reflect a passive kinematic signal's influence on the score relative to the other passive kinematic signals. Here, the “WiFi” passive kinematic signal with a weight of 0.5 is a weaker indicator of the stay state than the “docked” passive kinematic signal with a weight of 1. Also, the “carkit” passive kinematic signal with a weight of −1.2 is a stronger indication that the computing device is in a move state than the “docked” passive kinematic signal with a weight of +1 is that the computing device is in a stay state.

Table 1 provides output scores determined by the stay state equation of this example based on various combinations of the three passive kinematic signals to show how output scores reflect the observations discussed above.

TABLE 1

| | | | STAY | |
|---|---|---|---|---|
| WiFi | docked | carkit | Score | Comment |
| 1 | 1 | 0 | 0.817574 | Wifi & Docked, both contribute to a |
| | | | | higher score |
| 0 | 1 | 0 | 0.731059 | Docked only, medium stay indication |
| 1 | 0 | 0 | 0.622459 | Wifi only, weak stay indication |
| 0 | 0 | 0 | 0.5 | no signals- indeterminate |
| 0 | 1 | 1 | 0.450166 | Carkit is stronger than Docked, |
| | | | | moving towards not staying (<<0.5) |
| 1 | 0 | 1 | 0.331812 | Carkit is much stronger than Wifi, |
| | | | | moving towards not staying (<<0.5) |

Kinematic state analysis component 220 in this example would also provide the three passive kinematic signals into a move state equation to determine a score for the move state. For example, the move state equation may be as simple as:

Pₘₒᵥₑ(WiFi,docked,carkit)=(1−P_{stay}) Equation 2:

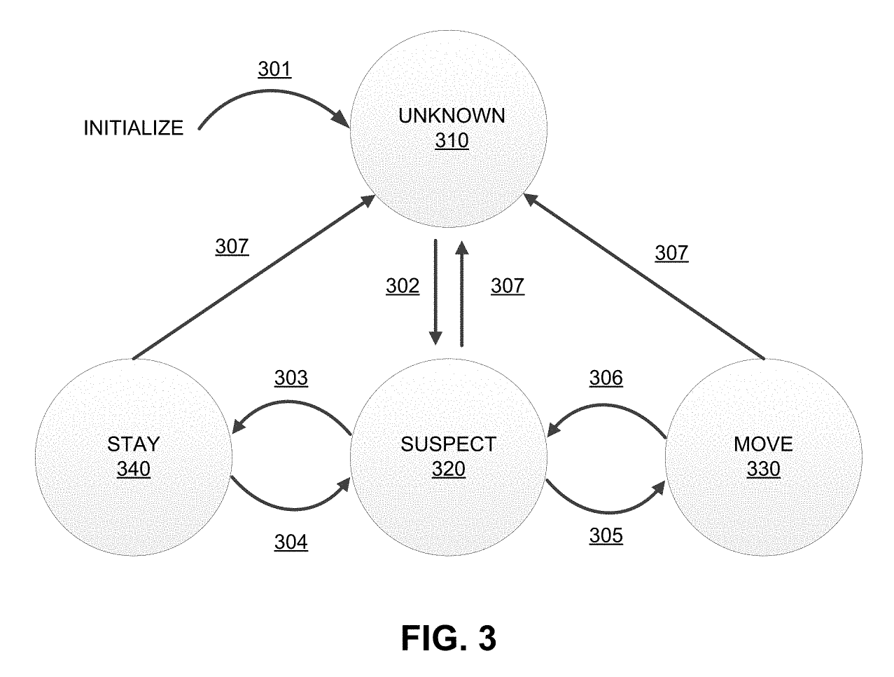

In some instances as in this example, the stay state equation and the move state equation may both return a low score, which indicates that the scores for the move state and stay state have each failed to exceed their respective “indeterminate” thresholds. In these instances, system 200 may be unable to determine the current kinematic state of the computing device. For example, this may occur on computing devices with limited sensing capabilities (e.g., a desktop personal computer). After a predetermined period of time in this uncertain state, system 200 may transition to the unknown state, as discussed below with reference to FIG. 3.

In an embodiment, kinematic state analysis component 220 may also determine an interest level score upon determining the computing device is in a stay state. In an embodiment, an interest level score may be determined using information associated with a mapping application. The interest level score may indicate how interesting a location associated with the stay state is to a user of the computing device. For a typical application, a STAY at a store can be considered more interesting than a STAY at a traffic light.

In an embodiment, an interest level score may be used to prioritize stay states associated with “interesting” locations over stay states associated with “uninteresting” locations when the computing device is running low on power. In an embodiment, an “interesting” location may be referred to as a visit. In an embodiment, an interest level score may be used to adjust aspects of system 200 when an “interesting” stay state is being detected. Also, the relative prioritization of “interesting” vs. “uninteresting” can be adjusted dynamically based on the current client applications. A traffic app may be interested in the “less interesting” stops in traffic, while another client application may not care at all (or may even want to avoid them). For example, system 200 may relax timer values upon determining an interest level exceeds a predefined threshold value for faster detection of “interesting” locations. In an embodiment, an interest level score may fall within a range of [0,1].

Budgetary component 230, is generally configured to control consumption of the computing device's available resources by system 200. Budgetary component 230 controls such consumption by implementing a system budget that limits a number of active operations (e.g., GPS polling, WiFi scans, activity detection with sensors, etc.) triggered by system 200 within a predefined time period. In an embodiment, the active operations may result in signals that are used in determining a kinematic state score. Kinematic state scores may be determine for defined kinematic states, such as stay or move. For example, a system budget may limit system 200 to triggering thirty active operations per day. The budget implemented by budgetary component 230 may further subject each kinematic state to a different budget. The term budget as used herein may also be referred to as a limit.

In an embodiment, a budget may impose limits on transitions from any kinematic state (i.e., stay state, move state, or unknown state) into the suspect state. It should be understood that the present disclosure is intended to introduce the basic concepts of the disclosed invention. To clarify, system 200 is intended to limit expensive operations, such as active operations, to a limited set of states, to better control the costs associated with executing the expensive operations. While the present disclosure describes the suspect state as the primary “expensive” state, one skilled in the art may likewise decide to perform a limited number of expensive operations in other states as well as a matter of design choice. For simplicity, the present disclosure describes the suspect state as the only expensive state of this example system.

As discussed above, kinematic state determinations have an associated uncertainty. Budget component 230 may conserve the system budget by further partitioning a kinematic state's budget based on kinematic state scores, interesting stay scores, or a combination thereof. For example, budgetary component 230 may specify a budget for transitions associated with higher kinematic state scores when there's a higher likelihood that active operations will result in confirming the computing device is in a stay state or a move state.

As another example, budgetary component 230 may specify a budget for transitions associated with higher interesting stay scores. By doing so, budgetary component 230 may reserve a portion of the system budget to stays associated with locations that are more important for the user like the user's home, work, gym, etc. As another example, budgetary component 230 may specify a budget for transitions associated with lower kinematic state scores when there's a lower likelihood that active operations will result in confirming the computing device is in a stay state or a move state.

In an embodiment, budgetary component 230 may implement a hierarchy among the partitioned budgets based on kinematic state scores, interesting stay scores, or a combination thereof. Under the hierarchy each kinematic state transition will consume from one of the partitioned budgets according to the kinematic state scores and/or interesting stay scores. If a higher score transition budget is depleted, the kinematic state transition may consume budget allocated to lower score kinematic state transitions. In contrast, if a lower score transition budget is depleted, the kinematic state transition may not consume budget allocated to higher score kinematic state transitions. Using this hierarchy, budgetary component 230 facilitates transitions of various confidence levels, while preventing lower confidence transitions from “starving” higher confidence ones. In an embodiment, a lower confidence may refer to a lower kinematic state score.

In an embodiment, budgetary component 230 is further configured to dynamically adjust budgets using current system state information of the computing device. Examples of such current system state information include whether the computing device is connected to an AC power source or a battery power source, whether a display screen of the computing device is active or inactive (e.g., ON or OFF), characteristics of applications listening for visit detections by system 200, etc. In the example of the power sources, budgetary component 230 may loosen budgetary restrictions when the computing device is connected to the AC power source. In the example of the listening applications, budgetary component 230 may adjust to a lower budget when the listening applications are known to require visit detection data with coarser granularity (e.g., a weather app).

Notification component 240, is generally configured to provide other applications executing on the computing device with visit detection-related notifications. In an embodiment, notification component 240 may be implemented using an application programming interface. In cooperation with kinematic state analysis component 220, notification component 240 provides the other applications with notifications upon determining the computing device has transitioned from one kinematic state to another. For example, notification component 240 may provide such notifications when the computing device has entered a stay state, exited a stay state, or remains in a move state. The notifications may include such information as the computing device's: current position, current speed, a stay radius associated with a stay state, a duration of a stay/move state, and the like. In an embodiment, notification component 240 may issue notifications to the other applications upon determining one or more of the stay state or move state scores exceed a predetermined threshold (e.g., 0.7).

FIG. 3 shows a state diagram with four operation modes of an example visit detection system 300 that may be implemented for reduced power visit detection by monitoring passive kinematic signals of a computing device. The four operation modes are an unknown mode 310, a suspect mode 320, a stay mode 330, and a move mode 340. Among the four operation modes, the stay mode 330 and the move mode 340 are the modes in which system 300 may primarily operate. When operating in the stay mode 330 and the move mode 340, system 300 may attempt to minimize active operations that excessively deplete the computing device's available resources.

Also, in each of the four operation modes, system 300 continues to monitor passive kinematic signals to determine the computing device's current kinematic state. To facilitate reduced power visit detection, each of the four operation modes is subject to different budgetary limitations, as described above. The transitions 301-307 denote times when the system 300 will switch from using one operation mode to another. As shown by transition 301, system 300 may initialize in the unknown mode 310.

In the unknown mode 310, system 300 is mostly idle and does not perform any active operations. As indicated by transition 307, system 300 may switch to the unknown mode 310 from any other operation mode when it is unable to determine a current kinematic state of the computing device from passive kinematic signals. System 300 may also operate in the unknown mode 310 when a current location of the computing device is unavailable. One reason the current location may be unavailable is system 300 lacks permission from a user of the computing device to determine the current location. Another reason the current location may be unavailable is that a current environment of the computing device prevents system 300 from obtaining location information. When operating in the unknown mode 310, system 300 may periodically (e.g., “every few hours” or when the passive kinematic signals start returning probability higher than “undetermined” for another state.) switch to the suspect mode 320 to determine the current location, as shown by transition 302.

In suspect mode 320, system 300 may trigger active operations to poll for the current location of the computing device (e.g., by polling a GPS receiver, initiating WiFi scans, etc.). For example, if a location of the computing device has not been obtained within a specified time, system 300 may poll for the current location while in suspect mode 320. In an embodiment, system 300 may trigger a subsequent active operation after a predefined time (e.g., 5 minutes) from a first polling operation to poll for an updated location of the computing device. In this embodiment, the subsequent active operation may be omitted if sensor-based activity detection (e.g., inertial data) is available to confirm the computing device is in a move or stay kinematic state.

To facilitate reduced power visit detection, system 300 may operate in suspect mode 320 for a limited duration as part of its budgetary limitations. One goal of operating in suspect mode 320 is to transition to one of the other operating modes that consume less of the computing device's available resources. As such, system 300 may monitor existing signals to confirm a stay state score and/or a move state score and transition to stay mode 330 or move mode 340, accordingly. If an initial location and a final location obtained in suspect mode 320 indicate the computing device is in a stay kinematic state, system 300 follows transition 303 to stay mode 330. Alternatively, if the initial location and the final location obtained in suspect mode 320 indicate the computing device is in a move kinematic state, system 300 follows transition 305 to move mode 340. As discussed above, system 300 may also follow transition 307 to unknown mode 310 for at least the reasons discussed above.

Below is an example of pseudo code that reflects an embodiment of how system 300 may operate in suspect mode 320 for a limited duration as part of its budgetary limitations:

While ((score(stay) < 0.5) AND (score(move) < 0.5)
AND (timer < 5min))
{

// listen to passive signals
// attempt to improve the scores by polling GPS or running some

other expensive operation
}

// if we exited the loop with indeterminate scores, move to
UNKNOWN.
Otherwise transition to the state that had higher score

In stay mode 340, system 300 may reduce its consumption of available resources and wait for an indication that the computing device is in a move kinematic state. For example, system 300 may follow transition 304 to suspect mode 320 upon determining any combination of a stay state and move state scores indicate the computing device is possibly moving. If hardware offloaded (or other type of low power) geo-fencing is available, system 300 may also transition to suspect mode 320 upon receiving a geo-fence exit signal indicative of a move. In an embodiment, subject to budgetary limitations, system 300 may also periodically (e.g., every 5 minutes, 15 minutes, 20 minutes, etc.) follow transition 304 to suspect mode 320 to confirm the computing device is still in a stay kinematic state.

In move mode 330, system 300 reduces its consumption of available resources and waits for an indication that the computing device is in a stay kinematic state. For example, system 300 may follow transition 306 to suspect mode 320 upon determining a stay state score is higher than a move state score using passive kinematic signals. In an embodiment, system 300 may be prevented from transitioning to suspect mode 320 if a sufficient budget is unavailable for the transition based one or more of the state scores.

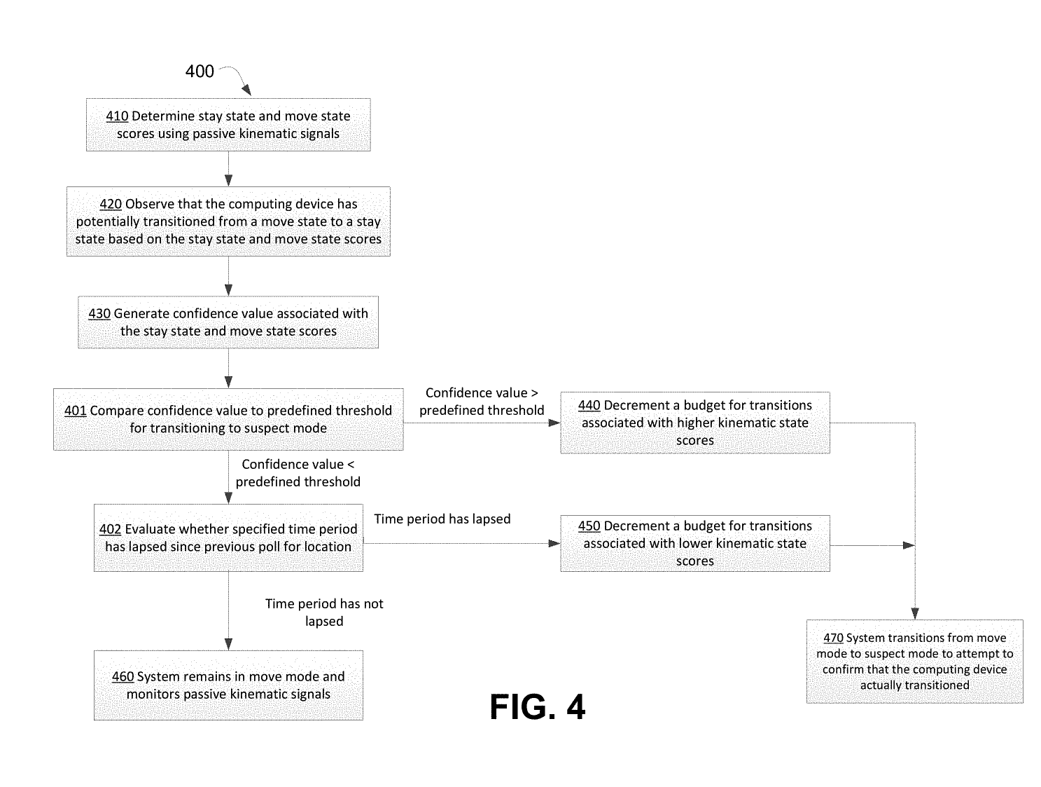

FIG. 4 is a flow diagram showing an example method 400 of operating a visit detection system with multiple modes of operation by monitoring passive kinematic signals. In the example of FIG. 4, the method assumes that a computing device is in a move state and a visit detection system of the computing device is operating in a move mode (e.g., move mode 330 of FIG. 3) when the method begins. In step 410, the system determines a stay state score and a move state score using passive kinematic signals. In an embodiment, the system may determine the stay score, the move score, or a combination thereof is too low to determine a kinematic state of the computing device. In this embodiment, the method may proceed from step 410 to step 460. In step 420, the system observes that the computing device has potentially transitioned from the move state to a stay state based on the stay state score and the move state score.

In step 430, the system generates a confidence value associated with the move state and stay state scores. In an embodiment, the confidence value is indicative of a probability that the observed kinematic state transition corresponds to an actual kinematic state transition by the computing device. In step 401, the system compares the confidence value to a predefined threshold value for transitioning to a suspect mode. If the confidence value exceeds the predefined threshold, the method proceeds to step 440. If the confidence value does not exceed the predefined threshold, the method proceeds to step 402. In an embodiment, if one or more of the stay or move state scores is too

In step 440, the system decrements a budget for transitions associated with higher kinematic state scores, and the method proceeds to step 470. In an embodiment, the system may decrement a budget for transitions associated with lower kinematic state scores when available if the budget for transitions associated with higher kinematic state scores is depleted. In step 402, the system evaluates whether a specified time period has lapsed since the system last polled for a current location of the computing device. If the specified time period has lapsed, the method proceeds to step 450. If not, the method proceeds to step 460. In step 450, the system decrements a budget for transitions associated with lower kinematic state scores, and the method proceeds to step 470.

In step 460, the system remains in the move mode and monitors passive kinematic signals. In step 470, the system transitions from the move mode to the suspect mode to attempt to confirm that the computing device actually transitioned from the move state to the stay state. In an embodiment, during steps 440 or 450, the system may evaluate whether a sufficient budget allocated for a transition at a specific score. In this embodiment, if the system determines there is not a sufficient budget allocated for a transition at a specific score, the method proceeds to step 460 instead of step 470.

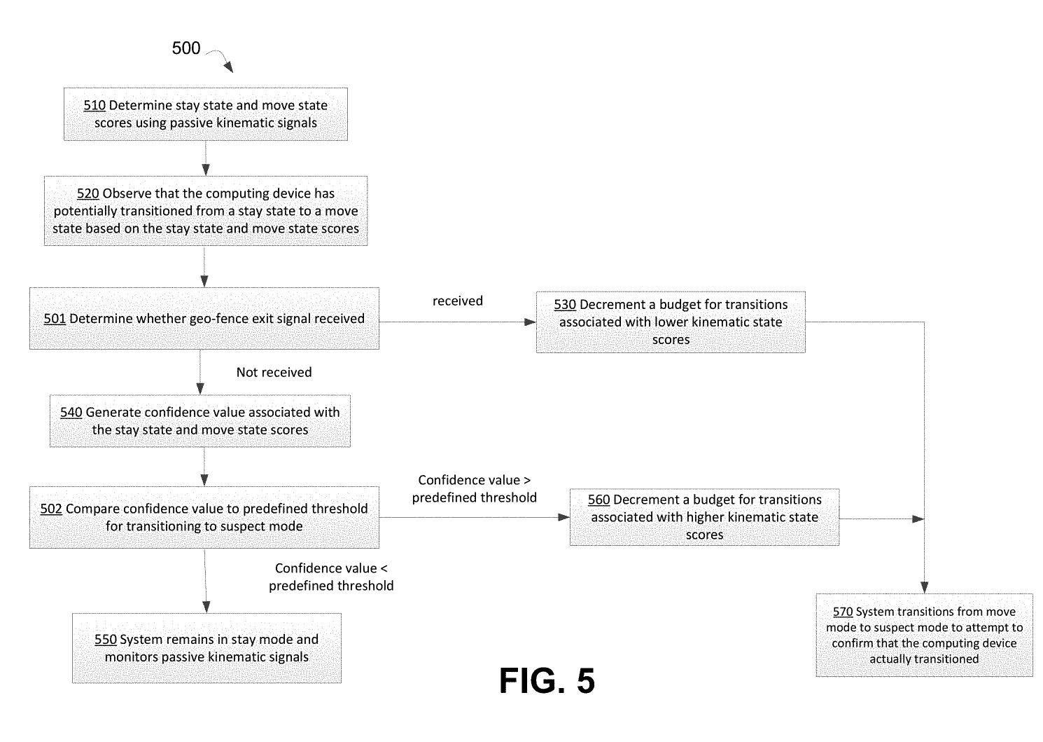

FIG. 5 is a flow diagram showing an example method 500 of operating a visit detection system with multiple modes of operation by monitoring passive kinematic signals. In the example of FIG. 5, the method assumes that a computing device is in a stay state and a visit detection system of the computing device is operating in a stay mode (e.g., stay mode 340 of FIG. 3) when the method begins. In step 510, the system determines a stay state score and a move state score using passive kinematic signals. In step 520, the system observes that the computing device has potentially transitioned from the stay state to a move state based on the stay state score and the move state score. In step 501, the system determines whether a geo-fence a geo-fence exit signal indicative of a move by the computing device was received when a hardware offloaded (or other type of low power) geo-fencing is available. If the geo-fence exit signal was received, the method proceeds to step 530. If not, the method proceeds to step 540.

In step 530, the system decrements a budget for transitions associated with lower kinematic state scores, and the method proceeds to step 570. In step 540, the system generates a confidence value associated with the move state and stay state scores. In an embodiment, the confidence value is indicative of a probability that the observed kinematic state transition corresponds to an actual kinematic state transition by the computing device. In step 502, the system compares the confidence value to a predefined threshold value for transitioning to a suspect mode. If the confidence value exceeds the predefined threshold, the method proceeds to step 560. If not, the method proceeds to step 550.

In step 550, the system remains in the stay mode and monitors passive kinematic signals. In step 560, the system decrements a budget for transitions associated with higher kinematic state scores, and the method proceeds to step 570. In an embodiment, the system may decrement a budget for transitions associated with lower kinematic state scores when available if the budget for transitions associated with higher kinematic state scores is depleted. In step 570, the system transitions from the stay mode to the suspect mode to attempt to confirm that the computing device actually transitioned from the stay state to the move state.

An embodiment may be implemented as a method for controlling location determination of a computing device. The method may comprise:

accessing, by the computing device, data indicative of signals associated with the computing device and location data generated by applications executing on the computing device;

based at least in part on the data, determining an initial kinematic state of the computing device;

monitoring the data indicative of signals associated with the computing device and location data;

determining, by the computing device based on the monitored data, that the computing device has potentially transitioned from the initial kinematic state based on one or more kinematic state scores;

generate a confidence value associated with the kinematic state scores, wherein the confidence value is indicative of a probability that an observed kinematic state transition corresponds to an actual kinematic state transition by the computing device;

changing the kinematic state for the computing device when the confidence value exceeds a predefined threshold value; and

controlling the location determination on the computing device based on the changed kinematic state.

In an embodiment, the initial kinematic state is a move state.

In an embodiment, the further comprises decrementing a limit for transitions, wherein limits for higher kinematic state scores are decremented before limits for transitions associated with lower kinematic state scores.

In an embodiment, limits for lower kinematic state scores are decremented when limits for transitions associated with higher kinematic state scores are depleted.

In an embodiment, the method further comprises determining whether a specified time period has lapsed since a previous poll for a current location of the computing device, wherein when the specified time period has not lapsed, a limit for transitions associated with lower kinematic state scores is decremented.

In an embodiment, the method further comprises transitioning to a suspect mode and confirming that the computing device actually transitioned states prior to changing the kinematic state.

In an embodiment, a computing device may be implemented. The computing device comprises one or more processors that are configured to execute one or more instructions that cause the computing device to perform operations comprising:

accessing data indicative of signals indicative of a state of the computing device and opportunistic location data generated by applications executing on the computing device;

based at least in part on the data, determining an initial kinematic state of the computing device;

monitoring the data indicative of signals associated with the computing device and opportunistic location data;

determining, based on the monitored data, that the computing device has potentially transitioned from the initial kinematic state based on one or more kinematic state scores having a confidence value indicative of a probability that an observed kinematic state transition corresponds to an actual kinematic state transition by the computing device;

changing the kinematic state for the computing device when a exceeds a predefined threshold value; and

controlling a location determination on the computing device based on the changed kinematic state.

In an embodiment, the kinematic state is maintained using a state machine having four location determination operating modes: an unknown mode, a suspect mode, a stay mode, and a move mode.

In an embodiment, the data comprises passive kinematic signals comprising one or more of device state data, network connection data, application activity data, and inertial data.

In an embodiment, the network connection data is indicative of one or more of whether the computing device is paired with a Bluetooth system, a wired Ethernet connection, a wireless access point, indications of variation in a number of visible wireless access points, and signal strength measurements.

In an embodiment, the application activity data is indicative of one or more of whether a user is capturing image data with a camera of the computing device, credit card or other payment transactions completed with the computing device, completion of a navigation session associated with a mapping application, and receiving geo-fence events for geo-fences set by other applications.

In an embodiment, the kinematic state scores are determined by taking a weighted average of individual passive kinematic signals.

In an embodiment, the location determination is determined based on a system limit that limits a number of active operations of the computing device within a predefined time period.

In an embodiment, the location determination is determined based on an interest level score that is determined using information associated with a mapping application.

In an embodiment, the interest level score is indicative of an interest level associated with a stay state and a user of the computing device.

In an embodiment, the kinematic state is determined based on a rule-based inference function that receives as input the data indicative of signals indicative of a state of the computing device and opportunistic location data.

In an embodiment, a computer-readable storage medium may be implemented. The computer-readable storage medium has stored therein computer-executable instructions that, upon execution by one or more processors of a computing device, at least cause the computing device to:

access data indicative of signals indicative of a state of the computing device and opportunistic location data generated by applications executing on the computing device;

based at least in part on the data, determine an initial kinematic state of the computing device;

monitor the data indicative of signals associated with the computing device and opportunistic location data;

determine, based on the monitored data, that the computing device has potentially transitioned from the initial kinematic state based on one or more kinematic state scores having a confidence value indicative of a probability that an observed kinematic state transition corresponds to an actual kinematic state transition by the computing device;

change the kinematic state for the computing device when the confidence value exceeds a predefined threshold value; and

control location determination functions on the computing device based on the changed kinematic state.

In an embodiment, controlling the location determination functions is further based on whether a geo-fence exit signal indicative of a move by the computing device was received.

In an embodiment, the computer-readable storage medium further comprises computer-executable instructions that, upon execution by one or more processors of a computing device, at least cause the computing device to decrement a limit for transitions, wherein limits for higher kinematic state scores are decremented before limits for transitions associated with lower kinematic state scores.

In an embodiment, limits for lower kinematic state scores are decremented when limits for transitions associated with higher kinematic state scores are depleted.

The illustrations of the aspects described herein are intended to provide a general understanding of the structure of the various aspects. The illustrations are not intended to serve as a complete description of all of the elements and features of apparatus and systems that utilize the structures or methods described herein. Many other aspects may be apparent to those of skill in the art upon reviewing the disclosure. Other aspects may be utilized and derived from the disclosure, such that structural and logical substitutions and changes may be made without departing from the scope of the disclosure. Accordingly, the disclosure and the figures are to be regarded as illustrative rather than restrictive.

The techniques, or certain aspects or portions thereof, may, for example, take the form of program code (i.e., instructions) embodied in tangible storage media or memory media implemented as storage devices, such as magnetic or optical media, volatile or non-volatile media, such as RAM (e.g., SDRAM, DDR SDRAM, RDRAM, SRAM, etc.), ROM, etc., that may be included in computing devices or accessible by computing devices. When the program code is loaded into and executed by a machine, such as a computer, the machine becomes an apparatus for practicing the disclosure. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the disclosure, e.g., through the use of an application programming interface (API), reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

It should be understood that the various techniques described herein may be implemented in connection with hardware or software or, where appropriate, with a combination of both. The subject matter presented herein may be implemented as a computer process, a computer-controlled apparatus or a computing system or an article of manufacture, such as a computer-readable storage medium. The terms “circuitry”, “component”, or “module” are used interchangeably throughout and include hardware components such as hardware interrupt controllers, hard drives, network adaptors, graphics processors, hardware based video/audio codecs, and the firmware used to operate such hardware. The terms “circuitry”, “component”, or “module” can also include microprocessors, application specific integrated circuits, and processors, e.g., cores of a multi-core general processing unit that perform the reading and executing of instructions, configured by firmware and/or software. Processor(s) can be configured by instructions loaded from memory, e.g., RAM, ROM, firmware, and/or mass storage, embodying logic operable to configure the processor to perform a function(s).

In an example embodiment, where circuitry includes a combination of hardware and software, an implementer may write source code embodying logic that is subsequently compiled into machine readable code that can be executed by hardware. Since one skilled in the art can appreciate that the state of the art has evolved to a point where there is little difference between hardware implemented functions or software implemented functions, the selection of hardware versus software to effectuate herein described functions is merely a design choice. Put another way, since one of skill in the art can appreciate that a software process can be transformed into an equivalent hardware structure, and a hardware structure can itself be transformed into an equivalent software process, the selection of a hardware implementation versus a software implementation is left to an implementer.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

The previous description of the aspects is provided to enable a person skilled in the art to make or use the aspects. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

1. A method for controlling location determination of a computing device, the method comprising:
accessing, by the computing device, data indicative of signals associated with the computing device and location data generated by applications executing on the computing device;
based at least in part on the data, determining an initial kinematic state of the computing device;
monitoring the data indicative of signals associated with the computing device and location data;
determining, by the computing device based on the monitored data, that the computing device has potentially transitioned from the initial kinematic state based on one or more kinematic state scores;
generate a confidence value associated with the kinematic state scores, wherein the confidence value is indicative of a probability that an observed kinematic state transition corresponds to an actual kinematic state transition by the computing device;
changing the kinematic state for the computing device when the confidence value exceeds a predefined threshold value; and
controlling the location determination on the computing device based on the changed kinematic state.

2. The method of claim 1, wherein the initial kinematic state is a move state.

3. The method of claim 1, further comprising decrementing a limit for transitions, wherein limits for higher kinematic state scores are decremented before limits for transitions associated with lower kinematic state scores.

4. The method of claim 3, wherein limits for lower kinematic state scores are decremented when limits for transitions associated with higher kinematic state scores are depleted.

5. The method of claim 1, further comprising determining whether a specified time period has lapsed since a previous poll for a current location of the computing device, wherein when the specified time period has not lapsed, a limit for transitions associated with lower kinematic state scores is decremented.

6. The method of claim 5, further comprising transitioning to a suspect mode and confirming that the computing device actually transitioned states prior to changing the kinematic state.

7. A computing device comprising one or more processors that are configured to execute one or more instructions that cause the computing device to perform operations comprising:
accessing data indicative of signals indicative of a state of the computing device and opportunistic location data generated by applications executing on the computing device;
based at least in part on the data, determining an initial kinematic state of the computing device;
monitoring the data indicative of signals associated with the computing device and opportunistic location data;
determining, based on the monitored data, that the computing device has potentially transitioned from the initial kinematic state based on one or more kinematic state scores having a confidence value indicative of a probability that an observed kinematic state transition corresponds to an actual kinematic state transition by the computing device;
changing the kinematic state for the computing device when a exceeds a predefined threshold value; and
controlling a location determination on the computing device based on the changed kinematic state.

8. The computing device of claim 7, wherein the kinematic state is maintained using a state machine having four location determination operating modes: an unknown mode, a suspect mode, a stay mode, and a move mode.

9. The computing device of claim 7, wherein the data comprises passive kinematic signals comprising one or more of device state data, network connection data, application activity data, and inertial data.

10. The computing device of claim 9, wherein the network connection data is indicative of one or more of whether the computing device is paired with a Bluetooth system, a wired Ethernet connection, a wireless access point, indications of variation in a number of visible wireless access points, and signal strength measurements.

11. The computing device of claim 9, wherein the application activity data is indicative of one or more of whether a user is capturing image data with a camera of the computing device, credit card or other payment transactions completed with the computing device, completion of a navigation session associated with a mapping application, and receiving geo-fence events for geo-fences set by other applications.

12. The computing device of claim 7, wherein the kinematic state scores are determined by taking a weighted average of individual passive kinematic signals.

13. The computing device of claim 7, wherein the location determination is determined based on a system limit that limits a number of active operations of the computing device within a predefined time period.

14. The computing device of claim 7, wherein the location determination is determined based on an interest level score that is determined using information associated with a mapping application.

15. The computing device of claim 14, wherein the interest level score is indicative of an interest level associated with a stay state and a user of the computing device.

16. The computing device of claim 7, wherein the kinematic state is determined based on a rule-based inference function that receives as input the data indicative of signals indicative of a state of the computing device and opportunistic location data.

17. A computer-readable storage medium having stored therein computer-executable instructions that, upon execution by one or more processors of a computing device, at least cause the computing device to:
access data indicative of signals indicative of a state of the computing device and opportunistic location data generated by applications executing on the computing device;
based at least in part on the data, determine an initial kinematic state of the computing device;
monitor the data indicative of signals associated with the computing device and opportunistic location data;
determine, based on the monitored data, that the computing device has potentially transitioned from the initial kinematic state based on one or more kinematic state scores having a confidence value indicative of a probability that an observed kinematic state transition corresponds to an actual kinematic state transition by the computing device;
change the kinematic state for the computing device when the confidence value exceeds a predefined threshold value; and
control location determination functions on the computing device based on the changed kinematic state.

18. The computer-readable storage medium of claim 17, wherein controlling the location determination functions is further based on whether a geo-fence exit signal indicative of a move by the computing device was received.

19. The computer-readable storage medium of claim 17, further comprising computer-executable instructions that, upon execution by one or more processors of a computing device, at least cause the computing device to decrement a limit for transitions, wherein limits for higher kinematic state scores are decremented before limits for transitions associated with lower kinematic state scores.

20. The computer-readable storage medium of claim 19, wherein limits for lower kinematic state scores are decremented when limits for transitions associated with higher kinematic state scores are depleted.
